(19) United States
(12) Patent Application Publication
(10) Pub. No.: US 2022/0045446 A1
(43) Pub. Date: Feb. 10, 2022

(54) HARNESS COMPONENT

(71) Applicant: SUMITOMO WIRING SYSTEMS, LTD., Mie (JP)

(72) Inventor: Yuta INOUE, Mie (JP)

(21) Appl. No.: 17/312,599

(22) PCT Filed: Dec. 5, 2019
(86) PCT No.: PCT/JP2019/047534

§ 371 Date: Jun. 10, 2021

(30) Foreign Application Priority Data
Dec. 14, 2018 (JP) 2018-234259

(51) Int. Cl. H01R 12/58; H01R 12/53; H01R 4/70

(52) U.S. Cl. CPC H01R 12/58; H01R 4/183; H01R 4/70; H01R 12/53

(57) ABSTRACT

A harness component (1) includes a plurality of terminals (2), a housing (3) and a plurality of electric wires (4). The plurality of terminals (2) each have a rod-shaped rod terminal portion (21) connected to a circuit board (11), and a bent terminal portion (22) formed by bending a conductive plate. The housing (3) has a plurality of through-holes (31) and a plurality of terminal storage holes (32). The rod terminal portions (21) of the respective terminals (2) pass through the through-holes (31). The bent terminal portions (22) are arranged in the respective terminal storage holes (32). The terminal storage holes (32) are connected to the through-holes (31) and each have an opening (321) on the side opposite to the corresponding through-hole (31). Each of the electric wires (4) is inserted into the terminal storage hole (32) from the corresponding openings (321). Each of the electric wires (4) is fastened to the corresponding bent terminal portion (22).

### TECHNICAL FIELD

The present invention relates to a harness component.

### BACKGROUND

A harness component described in Patent Document 1 includes a male connector to be mounted on one side in a thickness direction of a circuit board and a female connector connected to the male connector.

The male connector includes male terminals to be electrically connected to through holes of the circuit board and a male housing made of electrically insulating resin or the like for accommodating the male terminals. The male housing includes a connector fitting portion in the form of a bottomed tube open toward a side opposite to the circuit board. The female connector is fit into the connector fitting portion through the open side. Further, the male terminals are press-fit into a bottom wall of the connector fitting portion from the open side, and electrical contact portions, which are parts of the male terminals, project inside the connector fitting portion.

By fitting the female connector into the connector fitting portion of the male connector, the electrical contact portions and female terminals of the female connector are electrically connected.

### PRIOR ART DOCUMENT

### Patent Document

Patent Document 1: JP 2002-216870 A

### SUMMARY OF THE INVENTION

### Problems to be Solved

The female connector is thought to include the female terminals to be electrically connected to the male terminals and an electrically insulating female housing for accommodating the female terminals. However, in this case, two housing members, i.e. the male housing and the female housing, need to be connected, which tends to cause an increase in the number of components and enlargement. Further, the female terminals are interposed between wires and the male terminals connected to the circuit board, for which there is room for improvement in terms of reducing the number of components.

The present invention was developed in view of the above problem and aims to provide a harness component capable of reducing the number of components and miniaturization.

### Means to Solve the Problem

One aspect of the present invention is directed to a harness component with a plurality of terminals each including a rod-like rod terminal portion to be connected to a circuit board and a bent terminal portion formed by bending a conductive plate, a housing including a plurality of through holes, the rod terminal portions of the respective terminals being passed through the through holes, and a plurality of terminal accommodation holes communicating with the respective through holes, the bent terminal portions being disposed in the terminal accommodation holes, the terminal accommodation holes including openings on sides opposite to the through holes, and a plurality of wires disposed in the respective terminal accommodation holes through the respective openings, the bent terminal portions being crimped to the wires.

### Effect of the Invention

In the harness component of the above aspect, each terminal includes the rod terminal portion to be connected to the circuit board and the bent terminal portion to be crimped to the wire in the terminal accommodation hole. Thus, no other terminal is interposed between the terminal to be connected to the circuit board and the wire. Thus, the number of components is easily reduced, for example, as compared to the case where a female terminal and a male terminal are interposed between the wire and the circuit board. Further, a conventional structure for fitting two housing members, i.e. a male housing for accommodating male terminals and a female housing for accommodating female terminals is not adopted, and the number of the housing members can also be reduced. In this way, the miniaturization of the entire harness component is easily realized.

Each terminal is disposed in each terminal accommodation hole. Thus, in manufacturing the harness component, the terminal and the wire are easily positioned with respect to the housing by crimping a crimping portion of the terminal to the wire and subsequently inserting the terminal into the terminal accommodation hole. Further, since the plurality of terminals are inserted one by one into the respective terminal accommodation holes of the housing, the rattling of the terminal is prevented when the terminal is mounted into the housing. Therefore, the productivity of the harness component is easily improved.

As described above, according to the above aspect, it is possible to provide a harness component capable of reducing the number of components and miniaturization.

### BRIEF DESCRIPTION OF THE DRAWINGS

FIG. 1 is a perspective view of a harness component in one embodiment.

FIG. 2 is a plan view of the harness component mounted on a circuit board in the one embodiment.

FIG. 3 is a section along of FIG. 2 of the harness component when a retainer is at a full locking position with respect to a housing.

FIG. 4 is a back view of the harness component in the one embodiment.

FIG. 5 is a plan view of a terminal and a wire in the one embodiment.

FIG. 6A is a section along VIa-VIa of FIG. 5 and FIG. 6B is a section along VIb-VIb of FIG. 5.

FIG. 7 is a section showing a state where the terminal crimped to the wire is being mounted into the housing in the one embodiment.

FIG. 8 is a section of the harness component when the retainer is at a partial locking position with respect to the housing in the one embodiment.

### DETAILED DESCRIPTION TO EXECUTE THE INVENTION

### Embodiment

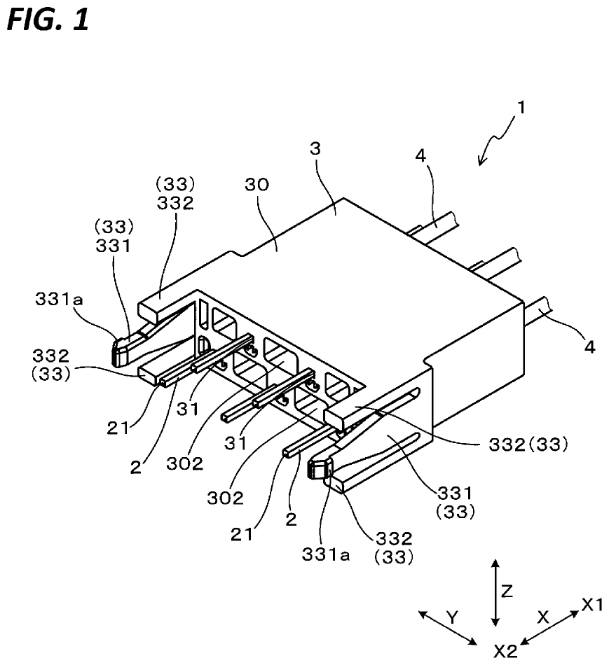

An embodiment of a harness component is described using FIGS. 1 to 8.

The harness component 1 of this embodiment includes a plurality of terminals 2, a housing 3 and a plurality of wires 4 as shown in FIGS. 1 to 3.

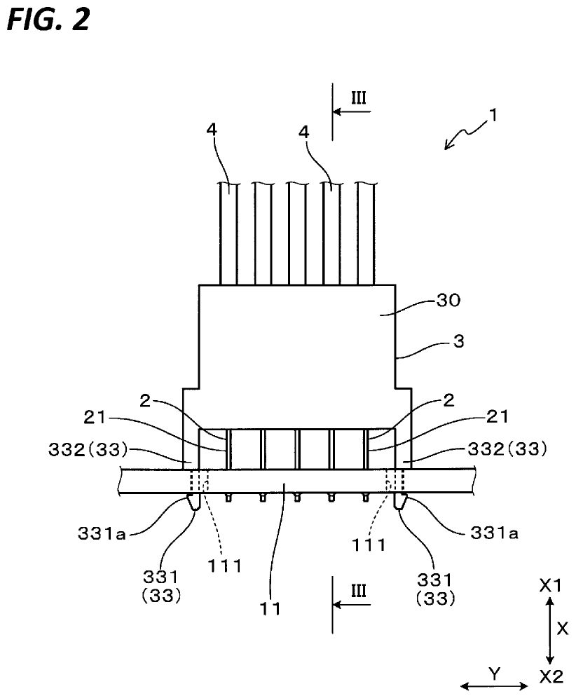

As shown in FIGS. 2, 3 and 5, each of the plurality of terminals 2 includes a rod-like rod terminal portion 21 to be connected to a circuit board 11 and a bent terminal portion 22 formed by bending a conductive plate.

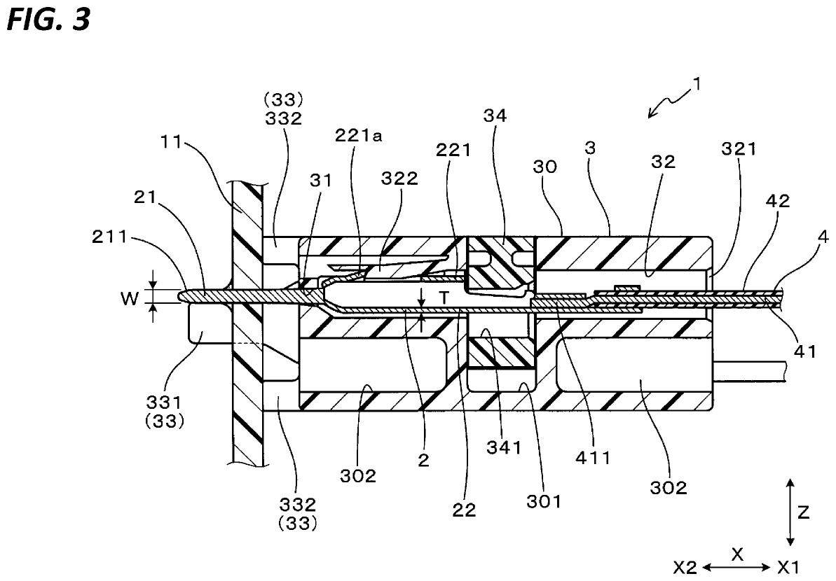

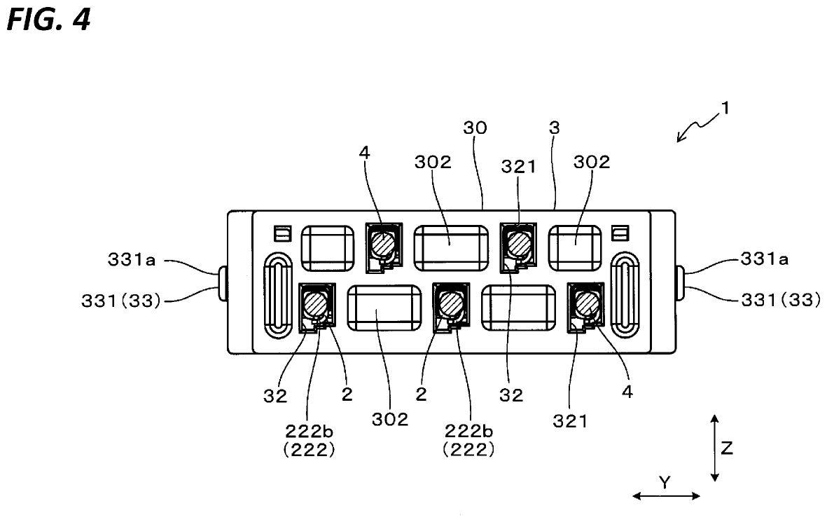

As shown in FIGS. 1 and 4, the housing 3 includes a plurality of through holes 31 and a plurality of terminal accommodation holes 32. As shown in FIG. 3, the rod terminal portion 21 of the terminal 2 is passed through the through hole 31. The bent terminal portion 22 is disposed in the terminal accommodation hole 32. Further, the terminal accommodation hole 32 communicates with the through hole 31 and includes an opening 321 on a side opposite to the through hole 31.

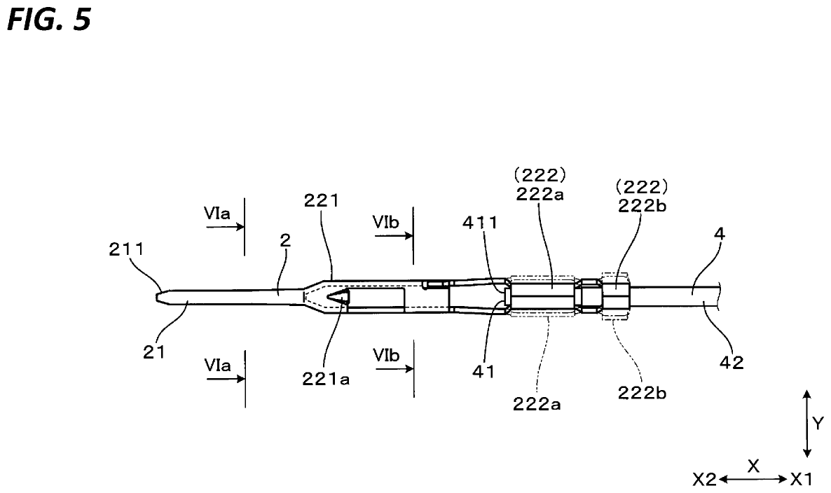

As shown in FIG. 3, the wire 4 is disposed in the terminal accommodation hole 32 through the opening 321. As shown in FIGS. 3 and 5, the bent terminal portion 22 is crimped to the wire 4. Note that the outer shape of the terminal 2 before crimping the bent terminal portion 22 is shown by a two-dot chain line in FIG. 5.

Hereinafter, a formation direction (axial direction) of the terminal accommodation hole 32 is referred to as an X direction. In the X direction, a side in the terminal accommodation hole 32 where the opening 321 is formed is referred to as an X1 side and a side in the terminal accommodation hole 32 where the through hole 31 is formed is referred to as an X2 side.

As shown in FIGS. 2 and 3, the harness component 1 electrically relays the circuit board 11 and an electronic device such as a control device by connecting the bent terminal portions 21 of the plurality of terminals 2 to the circuit board 11 and connecting the wires 4 to the electronic device.

The housing 3 is made of electrically insulating resin. As shown in FIG. 1, the housing 3 includes a housing body portion 30 in the form of a rectangular parallelepiped having a thickness in a Z direction orthogonal to the X direction, and housing engaging portions 33 projecting toward the X2 side from the housing body portion 30. As shown in FIG. 4, the housing body portion 30 includes five terminal accommodation holes 32 formed by recessing a surface on the X1 side toward the X2 side.

As shown in FIG. 4, out of the five terminal accommodation holes 32, three terminal accommodation holes 32 are formed on one side in the Z direction and the remaining two terminal accommodation holes 32 are formed on the other side in the Z direction. The five terminal accommodation holes 32 are arranged substantially at equal intervals in a Y direction orthogonal to both the X direction and Z direction. In the Y direction, the terminal accommodation holes 32 disposed on the one side in the Z direction and the terminal 2 accommodating portions disposed on the other side in the Z direction are alternately disposed.

As shown in FIG. 3, the terminal accommodation hole 32 is formed substantially in the entire housing body portion 30 in the X direction. The terminal accommodation hole 32 includes the opening 321 for causing an internal space thereof to be open toward the X1 side in an X1-side end part. Further, the through hole 31 is formed in a wall part of the housing 3 disposed on the X2 side in the internal space of the terminal accommodation hole 32. The terminal 2 is inserted into the terminal accommodation hole 32 through the opening 321 and the rod terminal portion 21 is inserted into the through hole 31. The through hole 31 is formed to have a slightly larger diameter than the rod terminal portion 21, so that the rod terminal portion 21 can be inserted thereinto.

As shown in FIG. 3, a locking lance 322 is formed on an X2-side end part of a side wall of the terminal accommodation hole 32. The locking lance 322 locks the terminal 2 inserted to a predetermined position of the terminal accommodation hole 32 from the X1 side. In this way, the terminal 2 is prevented from escaping toward the X1 side of the terminal accommodation hole 32 after being inserted to the predetermined position of the terminal accommodation hole 32.

As shown in FIG. 3, the locking lance 322 is formed to be long in the X direction and can be resiliently deflected in the Z direction. When the terminal 2 is inserted into the terminal accommodation hole 32, the locking lance 322 is resiliently deflected by being pushed by an engaged portion 221a formed on the terminal 2. The locking lance 322 is deflected in this way, whereby the entrance of the terminal 2 into the terminal accommodation hole 32 from the X1 side to the X2 side is allowed.

When the terminal 2 is inserted to the predetermined position of the terminal accommodation hole 32 as shown in FIG. 3, the engaged portion 221a of the terminal 2 is disposed on the X2 side of the locking lance 322 and the locking lance 322 enters the X1 side of the engaged portion 221a by a resilient restoring force of the locking lance 322. In this way, the locking lance 322 locks the engaged portion 221a of the terminal 2 from the X1 side of the engaged portion 221a to retain the terminal 2.

As shown in FIG. 3, a retainer arrangement portion 301 recessed from one side toward the other side in the Z direction is formed in a central part in the X direction of the housing body portion 30. A retainer 34 is locked in the retainer arrangement portion 301.

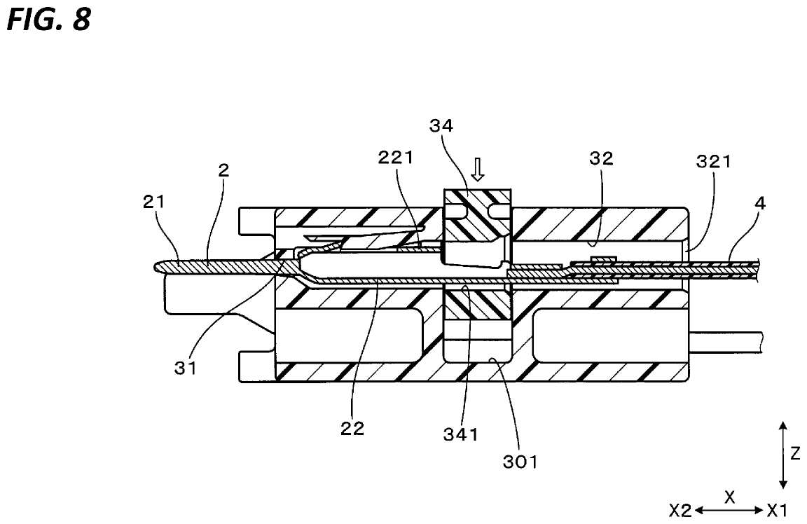

When the retainer 34 is at a partial locking position with respect to the housing 3, the terminals 2 are allowed to be mounted in and withdrawn from the terminal accommodation holes 32 of the housing 3. Further, when the retainer 34 is at a full locking position with respect to the housing 3, the terminals 2 inserted into the terminal accommodation holes 32 are retained by the retainer 34. FIG. 8 shows a state where the retainer 34 is at the partial locking position with respect to the housing 3, and FIG. 3 shows a state where the retainer 34 is at the full locking position with respect to the housing 3.

The retainer 34 includes five insertion holes 341 penetrating in the X direction. The respective insertion holes 341 are disposed in the mutually different terminal accommodation holes 32. When the retainer 34 is at the partial locking position and the full locking position with respect to the housing 3, the insertion holes 341 of the retainer 34 communicate with the terminal accommodation holes 32.

The insertion holes 341 are formed to have such a diameter that the terminals can be inserted in the X direction. When the retainer 34 is at the partial locking position with respect to the housing 3 as shown in FIG. 8, center axes of the insertion holes 341 substantially coincide with those of the terminal accommodation holes 32. Therefore, when the retainer 34 is at the partial locking position with respect to the housing 3, the terminals 2 are allowed to be mounted into and withdrawn from the terminal accommodation holes 32.

By pushing the retainer 34 at the partial locking position toward a back side of the retainer arrangement portion 301 of the housing 3 as shown in FIG. 8, the retainer 34 is disposed at the full locking position as shown in FIG. 3. When the retainer 34 is at the full locking position, parts of the retainer 34 enter spaces on the X1 sides of later-described tubular portions 221 of the bent terminal portions 22 of the terminals 2 inserted to the predetermined positions of the terminal accommodation holes 32. In this way, when the retainer 34 is at the full locking position, the retainer 34 locks the bent terminal portions 22 from the X1 side of the tubular portions 221 to prevent the escape of the terminals 2 from the terminal accommodation holes 32.

Further, as shown in FIGS. 1 and 4, both surfaces in the X direction of the housing body portion 30 are recessed in the X direction at positions adjacent to the terminal accommodation holes 32 in the Z direction and Y direction to form lightening portions 302. The lightening portions 302 are formed from the end surfaces in the X direction of the housing body portion 30 to positions before the retainer arrangement portion 301. The lightening portions 301 function to reduce the weight of the housing 3, prevent the formation of sinks in the housing 3 and the like.

As shown in FIGS. 1 and 2, the housing engaging portions 33 are integrally formed to the housing body portion 30. That is, the entire housing 3 including the housing engaging portions 33 and the housing body portion 30 is constituted by one member and is not formed, for example, by joining a plurality of members. The housing engaging portions 33 are formed from both ends in the Y direction of the housing body portion 30 on the X2 side.

As shown in FIG. 1, the housing engaging portion 33 includes a housing flexible piece 331 and housing restricting portions 332. The housing flexible piece 331 is formed from a central part in the Z direction of each of both ends in the Y direction of the housing body portion 30 on the X2 side.

As shown in FIGS. 1 and 2, the housing flexible piece 331 is in the form of a plate having a thickness in the Y direction and long in the X direction. The housing flexible piece 331 is configured to be resiliently deflectable in the Y direction. A pair of the housing flexible pieces 331 include engaging projections 331a formed to project toward sides away from each other in the Y direction on X1-side end parts.

As shown in FIG. 2, the pair of housing flexible pieces 331 are inserted into board engagement holes 111 formed to penetrate through the circuit board 11 in the Z direction. Here, when the pair of engaging projections 331a pass through the board engagement holes 111, the pair of housing flexible pieces 331 are inserted into the board engagement holes 111 while being deflected in directions toward each other along the Y direction. When the engaging projections 331a pass through the board engagement holes 111 and are disposed on the X2 side of the circuit board 11, the pair of housing flexible pieces 331 are deformed toward sides away from each other in the Y direction by resilient restoring forces and return to initial shapes. In this way, the engaging projections 331a are engaged with peripheral parts of the board engagement holes 111 in the circuit board 11 in the X direction to prevent the escape of the housing 3 from the board engagement holes 111.

As shown in FIG. 1, the housing restricting portions 332 are formed on both sides in the Z direction of the housing flexible piece 331. The housing restricting portions 332 are formed in parallel to the housing flexible piece 331. As shown in FIGS. 1 and 2, the housing restricting portions 332 are formed to be shorter in the X direction than the housing flexible piece 331 and end parts on the X2 side are formed to be located closer to the X1 side than an end part on the X2 side of the housing flexible piece 331.

As shown in FIG. 2, with the pair of housing flexible pieces 331 engaged with the board engagement holes 111 of the circuit board 11, surfaces on the X2 side of the housing restricting portions 332 are facing a surface on the X1 side of the circuit board 11. In this way, with the pair of housing flexible pieces 331 engaged with the board engagement holes 111 of the circuit board 11, the circuit board 11 is sandwiched between the housing restricting portions 332 and the engaging projections 331a of the housing flexible pieces 331. Thus, with the pair of housing flexible pieces 331 engaged with the board engagement holes 111 of the circuit board 11, a displacement in the X direction of the housing 3 with respect to the circuit board 11 is limited by the housing restricting portions 332 and the engaging projections 331a of the housing flexible pieces 331.

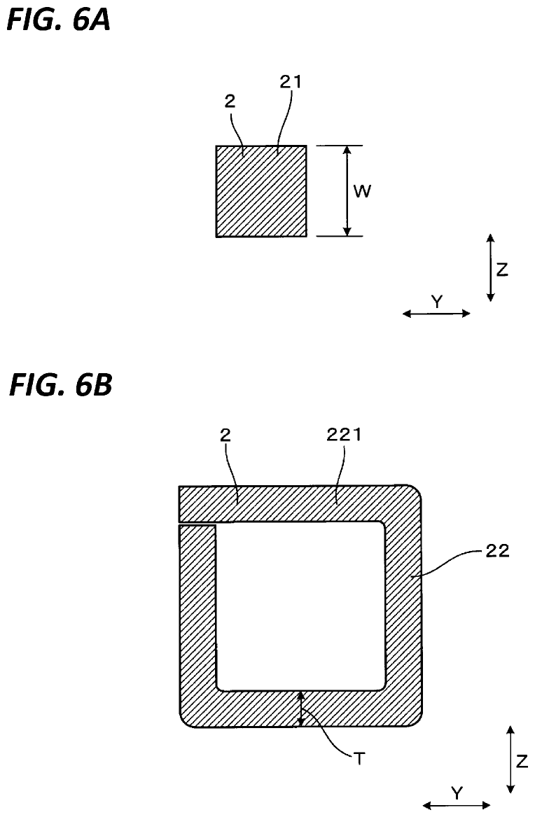

As shown in FIGS. 3 and 5, the terminal 2 includes the aforementioned rod terminal portion 21 and bent terminal portion 22. The rod terminal portion 21 is formed into a pin shape (column shape) long in the X direction. As shown in FIG. 6A, the rod terminal portion 21 has a convex polygonal or circular cross-sectional shape orthogonal to a longitudinal direction thereof (X direction). The convex polygonal shape means a polygonal shape, all the inner angles of which are respectively below 180°. In this embodiment, the rod terminal portion 21 has a substantially square cross-sectional shape.

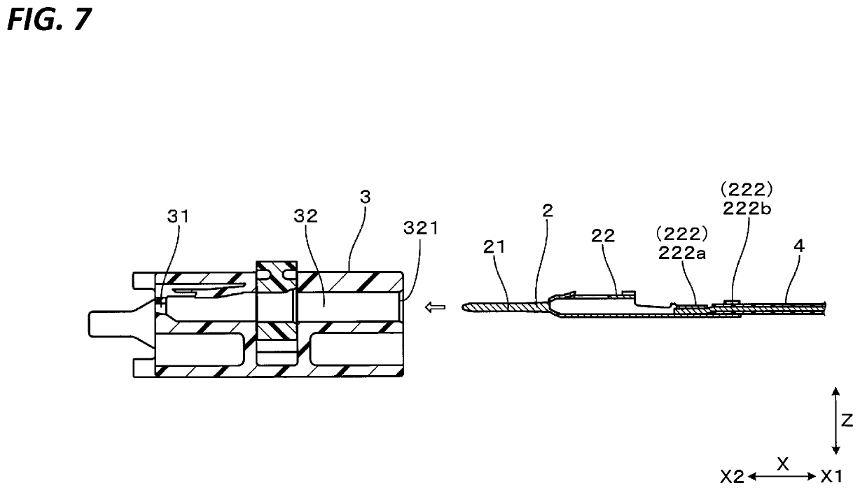

By inserting the terminal 2 into the terminal accommodation hole 32 through the opening 321 and inserting the rod terminal portion 21 into the through hole 31 as shown in FIG. 7, the terminal 2 is mounted in the housing 3. As shown in FIG. 3, most of the rod terminal portion 21 projects toward the X2 side from the through hole 31. Then, the rod terminal portion 21 is inserted into the through hole of the circuit board 11 in the X direction and soldered to the circuit board 11.

As shown in FIG. 3, the rod terminal portion 21 and the bent terminal portion 22 are constituted by a plastically processed product made of a single conductive raw material such as coper or copper alloy. That is, the rod terminal portion 21 and the bent terminal portion 22 are not integrated by joining metals different from each other. As shown in FIGS. 3 and 6, a thickness T of the bent terminal portion 22 is smaller than a minimum width W of the rod terminal portion 21. The minimum width W of the rod terminal portion 21 means a length of one side if the cross-sectional shape of the rod terminal portion 21 orthogonal to the longitudinal direction of the rod terminal portion 21 is square. Note that the minimum width W of the rod terminal portion 21 is a length of short sides if the cross-sectional shape is rectangular, a diameter if the cross-sectional shape is circular, and a length of a minor axis if the cross-sectional shape is elliptical.

As shown in FIGS. 3 and 5, in this embodiment, the rod terminal portion 21 includes a reduced-diameter portion 211 reduced in diameter toward the X2 side on an end part on the X2 side. The reduced-diameter portion 21 facilitates the insertion of the terminal 2 into the through hole 31. Here, the minimum width W of the rod terminal portion 21 is constant in a main part, but a minimum width W of the reduced-diameter portion 211 is smaller than that of the main part. In such a case, the minimum width W of the rod terminal portion 21 means that of the main part of the rod terminal portion 21.

For example, the minimum width W of the rod terminal portion 21 can be set to 0.25 mm and the thickness T of the bent terminal portion 22 can be set to 0.64 mm. As shown in FIG. 3, the thickness T of the bent terminal portion 22 is constant substantially in the entirety of the bent terminal portion 22.

Here, in manufacturing the terminal 2, a metal plate material having a thickness in the Z direction equal to that of the rod terminal portion 21 is prepared and a part of the metal material, which will become the bent terminal portion 22, is beaten, thinned and bent, whereby the terminal 2 can be manufactured.

As shown in FIGS. 3 and 5, the bent terminal portion 22 includes the tubular portion 221 and a crimping portion 222. As shown in FIG. 3, the tubular portion 221 is formed by bending the bent terminal portion 22 into a tubular shape. When the retainer 34 is at the full locking position with respect to the housing 3, a part of the retainer 34 is disposed on the X1 side of the tubular portion 221 and the terminal 2 is retained by the contact of the tubular portion 221 with the retainer 34 in the X direction.

As shown in FIGS. 3 and 5, the tubular portion 221 is formed with the engaged portion 221a on one side in the Z direction. The engaged portion 221a is formed to project more toward the one side in the Z direction toward the X1 side. As shown in FIG. 3, an X1-side end part of the engaged portion 221a is locked by the locking lance 322.

As shown in FIG. 5, the crimping portion 222 is crimped to an end part of the wire 4. The wire 4 includes a conductive portion 41 having conductivity and an electrically insulating coating portion 42 covering the conductive portion 41. The end part of the wire 4 serves as an exposed conductive portion 411 in which the conductive portion 41 is exposed from the coating portion 42. The crimping portion 222 includes a first crimping portion 222a to be crimped to the exposed conductive portion 411 and a second crimping portion 222b formed on the X1 side of the first crimping portion 222a and to be crimped to an end part of the coating portion 42. In FIG. 5, the first and second crimping portions 222a, 222b before being crimped are shown by a two-dot chain line.

Next, functions and effects of this embodiment are described.

In the harness component 1 of this embodiment, each terminal 2 includes the rod terminal portion 21 to be connected to the circuit board 11 and the bent terminal portion 22 to be crimped to the wire 4 in the terminal accommodation hole 32. Thus, no other terminal is interposed between the terminal 2 to be connected to the circuit board 11 and the wire 4. Therefore, the number of components is easily reduced as compared to the case where a female terminal and a male terminal are interposed between the wire 4 and the circuit board 11. Further, a conventional structure for fitting two housing members, i.e. a male housing for accommodating male terminals and a female housing for accommodating female terminals is not adopted, and the number of the housing members can also be reduced. In this way, the miniaturization of the entire harness component 1 is easily realized.

Further, each terminal 2 is disposed in each terminal accommodation hole 32. Thus, in manufacturing the harness component 1, the crimping portion 222 of the terminal 2 is crimped to the wire 4 and, subsequently, the terminal 2 is inserted into the terminal accommodation hole 32 as shown in FIG. 7, whereby the terminal 2 and the wire 4 are easily positioned with respect to the housing 3. Further, since the plurality of terminals 2 are inserted one by one into the respective terminal accommodation holes 32 of the housing 3, the rattling of the terminal 2 in mounting the terminal 2 into the housing 3 is prevented. Therefore, the productivity of the harness component 1 is easily improved.

Further, the rod terminal portion 21 and the bent terminal portion 22 are formed by the plastically processed product made of the single raw material, and the thickness T of the bent terminal portion 22 is smaller than the minimum width W of the rod terminal portion 21. Thus, a load required for bending is easily reduced in bending the bent terminal portion 22, for example, when the crimping portion 222 of the bent terminal portion 22 is crimped to the end part of the wire 4 or the like. Further, in the rod terminal portion 21, strength is easily ensured and the deformation of the rod terminal portion 21 can be prevented, for example, when the rod terminal portion 21 and the circuit board 11 are connected. Further, since the rod terminal portion 21 and the bent terminal portion 22 are formed by the plastically processed product made of the single raw material, the number of components and assembly man-hours of the entire harness component 1 can be reduced.

Further, the rod terminal portion 21 has a convex polygonal or circular cross-sectional shape orthogonal to the longitudinal direction of the rod terminal portion 21. Thus, the formation of voids in solder can be prevented, for example, as compared to the case where the rod terminal portion 21 is formed as a tab-like terminal formed by bending a plate-like metal member to have a U-shaped cross-section. That is, if the rod terminal portion 21 is formed into a tab shape, air remains in a space surrounded by the rod terminal portion 21 having a U-shaped cross-section and voids are easily formed in the solder. On the other hand, by forming the rod terminal portion 21 to have a convex polygonal or circular cross-section, there is no space surrounded by the rod terminal portion 21 in the cross-section of the rod terminal portion 21 orthogonal to the X direction, wherefore the formation of voids in the solder can be suppressed.

Further, the bent terminal portion 22 is formed with a retaining portion for preventing the terminal 2 from escaping from the terminal accommodation hole 32 by being locked to the housing 3. In this embodiment, the engaged portion 221a to be locked by the locking lance 322 in the inner terminal 2 portion and the tubular portion 221 to be locked to the housing 3 via the retainer 34 constitute the retaining portion. Since the relatively thin bent terminal portion 22 in the terminal 2 is formed with the retaining portion in this way, the bent terminal portion 22 is easily processed and the retaining portion is easily formed.

Further, the housing 3 integrally includes the housing engaging portions 33 to be engaged with the circuit board 11. Thus, the terminals 2 and the circuit board 11 can be joined such as by soldering after the housing 3 is engaged with the circuit board 11 at the housing engaging portions 33 and relative positions of the housing 3 and the circuit board 11 are fixed. Furthermore, since the housing 3 integrally includes the housing engaging portions 33, the number of components is not increased even if the housing engaging portions 33 are provided.

As described above, according to this embodiment, it is possible to provide a harness component capable of reducing the number of components and miniaturization.

The present invention is not limited to the above embodiment and can be applied to various embodiments without departing from the gist thereof. For example, inserted portions of terminals may be press-fit into through holes of a housing. Further, a housing can also be formed by insert molding with terminals connected to wires arranged inside a mold for the housing.

1. A harness component, comprising:
a plurality of terminals each including a rod-like rod terminal portion to be connected to a circuit board and a bent terminal portion formed by flattening and bending a part of a metal material leading to the rod terminal portion;
a housing including a plurality of through holes, the rod terminal portions of the respective terminals being passed through the through holes, and a plurality of terminal accommodation holes communicating with the respective through holes, the bent terminal portions being disposed in the terminal accommodation holes, the terminal accommodation holes including openings on sides opposite to the through holes; and
a plurality of wires disposed in the respective terminal accommodation holes through the respective openings, the bent terminal portions being crimped to the wires,
the rod terminal portion having a convex polygonal or circular cross-sectional shape orthogonal to a longitudinal direction of the rod terminal portion and having no space, the rod terminal portion being inserted into a through hole of the circuit board and soldered to the circuit board.

2-3. (canceled)

4. The harness component of claim 1, wherein the bent terminal portion is formed with a retaining portion for preventing the terminal from escaping from the terminal accommodation hole by being locked to the housing.

5. The harness component of claim 1, wherein the housing integrally includes a housing engaging portion to be engaged with the circuit board.
